(19) United States
(12) Patent Application Publication
(10) Pub. No.: US 2025/0133279 A1
(43) Pub. Date: Apr. 24, 2025

(54) CAMERA MODULE

(71) Applicant: SAMSUNG ELECTRO-MECHANICS CO., LTD., Suwon-si (KR)

(72) Inventor: Junho JEONG, Suwon-si (KR)

(73) Assignee: SAMSUNG ELECTRO-MECHANICS CO., LTD., Suwon-si (KR)

(21) Appl. No.: 18/777,204

(22) Filed: Jul. 18, 2024

(30) Foreign Application Priority Data
Oct. 18, 2023 (KR) 10-2023-0139272

(51) Int. Cl. H04N 23/51; G03B 11/00; H04N 23/54

(52) U.S. Cl. CPC H04N 23/51; G03B 11/00; H04N 23/54

(57) ABSTRACT

A camera module includes a lens barrel; an image sensor, mounted on a substrate, disposed below the lens barrel along an optical axis direction of the lens barrel; and a sub-housing, disposed between the lens barrel and the substrate, comprising a seating portion on which an infrared filter is accommodated, and a frame portion supported by the substrate. The sub-housing is configured to space apart the seating portion from the substrate. The sub-housing comprises an inner surface facing the image sensor and an outer surface facing away from the inner surface. The frame portion includes a gas discharge portion including a first channel communicating the inner surface with the outer surface in a first direction and a second channel extending from the first channel to the outer surface along the optical axis direction in a second direction different from the first direction.

### CROSS-REFERENCE TO RELATED APPLICATIONS

This application claims the benefit under 35 USC 119(a) of Korean Patent Application No. 10-2023-0139272 filed on Oct. 18, 2023, in the Korean Intellectual Property Office, the entire disclosure of which is incorporated herein by reference for all purposes.

### BACKGROUND

### 1. Field

The present disclosure relates to a camera module.

### 2. Description of the Related Art

Owing to remarkable developments in information and communication technology and semiconductor technology, the distribution and use of electronic devices are rapidly increasing. There is a trend in these electronic devices to provide a variety of functions through convergence, rather than staying within their own traditional areas.

Recently, cameras have been basically employed in portable electronic devices such as smartphones, tablet PCs, and laptop computers, and auto focus (AF) functions, image stabilization functions, zoom functions, etc., are being added to the cameras of these portable electronic devices.

In the case of adhesives such as epoxy resin used to adhesively fix the infrared filter of such a camera module and the sub-housing on which the infrared filter is mounted, gas is generated during curing. In order to discharge this gas, a space for gas discharge may be provided with a space engraved on the seating portion of the sub-housing, and there is a need for improvement since this space may allow foreign substances to enter or a flare phenomenon may occur.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; an image sensor, mounted on a substrate, disposed below the lens barrel along an optical axis direction of the lens barrel; and a sub-housing, disposed between the lens barrel and the substrate, comprising a seating portion on which an infrared filter is accommodated, and a frame portion supported by the substrate. The sub-housing is configured to space apart the seating portion from the substrate. The sub-housing comprises an inner surface facing the image sensor and an outer surface facing away from the inner surface. The frame portion includes a gas discharge portion including a first channel communicating the inner surface with the outer surface in a first direction and a second channel extending from the first channel to the outer surface along the optical axis direction in a second direction different from the first direction.

The frame portion may further include a connecting portion configured to space apart the seating portion from the substrate and extend from the seating portion, and a support portion disposed between the connecting portion and the substrate and supported by the substrate.

The first channel may penetrate the connecting portion to communicate inner and outer surfaces of the connecting portion.

The first channel may penetrate the support portion to communicate inner and outer surfaces of the support portion.

The camera module may further include a filler material disposed to fill at least a portion of the second channel.

The filler material may be disposed to fill a region where the first channel and the second channel overlap each other along the optical axis direction.

The filler material may include an epoxy resin.

An adhesive may be disposed between the seating portion and the infrared filter.

The adhesive may be disposed to cover a region where the seating portion and the infrared filter overlap.

The sub-housing may include a first opening penetrated by the first channel and positioned on the inner surface, and a second opening penetrated by the first channel and positioned on the outer surface.

The sub-housing may include a third opening penetrated by the second channel from the first channel in the optical axis direction and positioned on the outer surface.

The third opening and the second opening may be aligned along a direction perpendicular to the optical axis direction.

The third opening and the second opening may be disposed offset from a direction perpendicular to the optical axis direction.

The first opening may be positioned lower than the second opening in an optical axis direction of the sub-housing.

The first channel may extend in a direction perpendicular to the optical axis direction.

The first channel may extend in a straight line.

The first channel may have a plurality of bent portions.

The second channel may extend in a straight line.

Other features and aspects will be apparent from the following detailed description, the drawings, and the claims.

### BRIEF DESCRIPTION OF THE DRAWINGS

FIG. 1 is a schematic cross-sectional view of a camera module according to an embodiment.

FIG. 2 is a top plan view of a portion of a camera module according to an embodiment.

FIG. 3 is a perspective view of a portion of a camera module according to an embodiment.

FIG. 4 is an enlarged perspective view of a portion A of a camera module according to an embodiment.

FIG. 5 is a cross-sectional view showing a camera module in which a filler material is not disposed according to an embodiment taken along line V-V′ of FIG. 3.

FIG. 6 is a cross-sectional view showing a portion of a camera module according to an embodiment taken along line V-V′ of FIG. 3.

FIG. 7 is a cross-sectional view showing a portion of a camera module according to a modified embodiment taken along line V-V′ of FIG. 3.

FIG. 8 is a cross-sectional view showing a portion of a camera module according to another modified embodiment taken along line V-V′ of FIG. 3.

FIG. 9 is an enlarged perspective view of a portion A of a camera module according to another embodiment.

FIG. 10 is a cross-sectional view showing a portion of a camera module according to another embodiment taken along line V-V′ of FIG. 3.

FIG. 11 is a cross-sectional view showing a portion of a camera module according to a modified embodiment of another embodiment taken along line V-V′ of FIG. 3.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

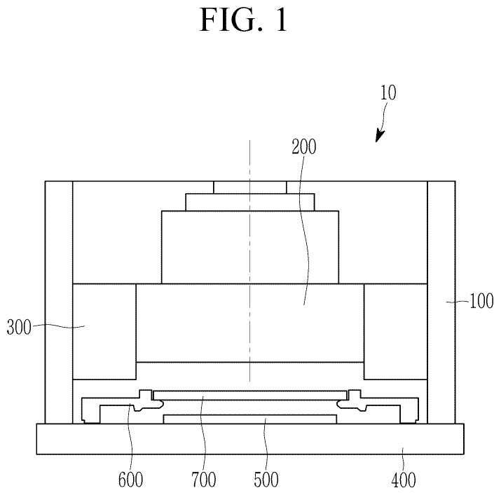

Referring to FIG. 1, a camera module according to an embodiment 10 will be described. FIG. 1 is a schematic cross-sectional view of a camera module according to an embodiment.

First, referring to FIG. 1, a camera module according to an embodiment 10 may include a housing 100, lens barrel 200, a lens driver 300, a substrate 400, an image sensor 500, a sub-housing 600, and an infrared filter 700.

The housing 100 may accommodate the lens barrel 200 and the lens driver 300. The housing 100 may have a polyhedral shape with a generally rectangular cross-section and a predetermined height. However, the shape of the housing 100 is not limited to a polyhedral shape having a rectangular cross-section.

The lens barrel 200 may be a cylindrical shape with a hollow space to accommodate a plurality of lenses for imaging a subject, and the plurality of lenses may be mounted on the lens barrel 200 along an optical axis. The plurality of lenses may be disposed in a desired quantity depending on the design of the lens barrel 200, and the lens may have the same or different optical characteristics, such as a refractive index. The lens barrel 200 may move in an optical axis direction or a direction perpendicular to the optical axis in a state accommodated in the housing 100 by the driving torque of the lens driver.

The lens driver is a device configured to mount and move the lens barrel 200, and may include an auto focus (AF) unit for adjusting the focus and an optical image stabilization (OIS) unit configured to compensate for hand shaking or swaying. For example, the lens driver may adjust the focus or implement the zoom function by moving the lens barrel 200 in the optical axis direction (Z-axis direction in the drawing) by using the AF unit, and may compensate hand shaking or swaying at the time of photographing by moving the lens barrel 200 in a direction perpendicular to the optical axis direction (X-axis or Y-axis direction in the drawing) by using the OIS unit.

The substrate 400 may be electrically connected to the lens driver 300. The substrate 400 may be a printed circuit board.

The image sensor 500 may be mounted on the substrate 400. The image sensor 500 may be positioned below the lens barrel 200 along the optical axis direction. The image sensor 500 may convert the light incident through the lens barrel 200 to an electric signal. For example, the image sensor 500 may be a charge-coupled device (CCD) or a complementary metal-oxide semiconductor (CMOS). The electric signal converted by the image sensor 500 may be output as an image through a display unit (not shown) of an electronic device equipped with a camera module 10. The image sensor 500 may be fixed to the substrate 400, and electrically connected to the substrate 400.

The sub-housing 600 and the infrared filter 700 mounted on the sub-housing 600 may be positioned between the lens barrel 200 and the substrate 400 on which the image sensor 500 is mounted. The infrared filter 700 may be disposed below the lens barrel 200, along the optical axis direction of the lens barrel 200. The infrared filter 700 may be positioned inside the sub-housing 600. The infrared filter 700 may be configured to block light of a wavelength. For example, the infrared filter 700 may be configured to block infrared rays. However, the light blocked by the infrared filter 700 is not limited to infrared rays.

The infrared filter 700 may be fixed using various methods. For example, the infrared filter 700 may be adhesively fixed by an ultraviolet (UV) curing adhesive material or a heat-curing adhesive material, and at this time, the adhesive material may be formed of epoxy material. In addition, other available adhesive means, such as adhesive tape, may also be used.

As such, the housing 100 and the sub-housing 600 may define an interior space configured to accommodate the lens barrel 200, the lens driver 300, or the image sensor 500.

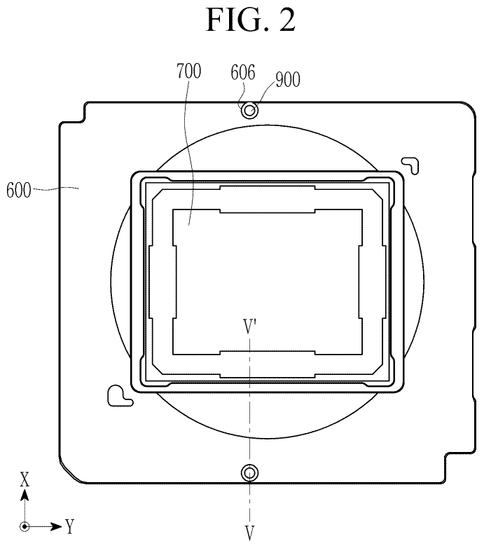

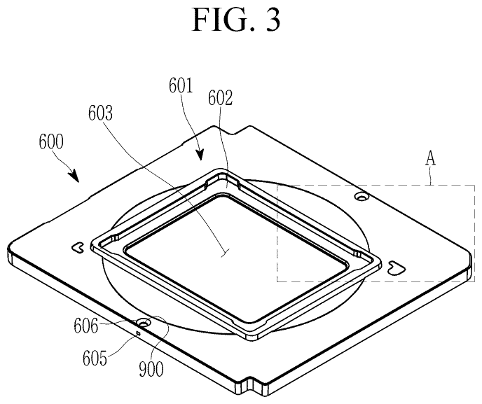

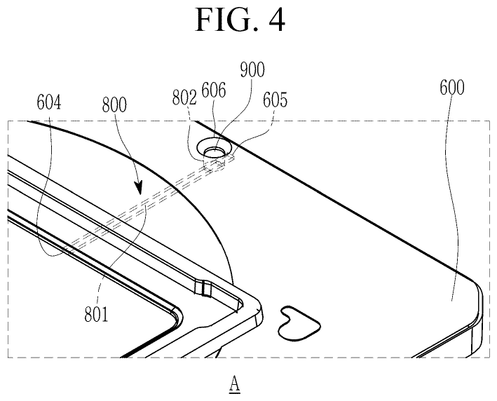

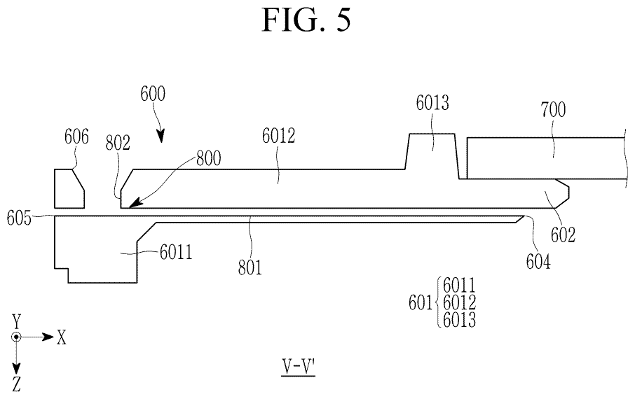

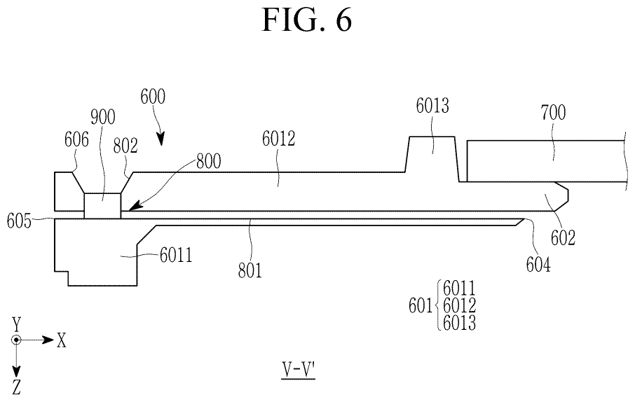

Hereinafter, referring to FIG. 2 to FIG. 6 together with FIG. 1, the sub-housing 600 of the camera module 10, according to the present embodiment, will be described in further detail. FIG. 2 is a top plan view of a portion of a camera module according to an embodiment. FIG. 3 is a perspective view of a portion of a camera module according to an embodiment. FIG. 4 is an enlarged perspective view of a portion A of a camera module according to an embodiment. FIG. 5 is a cross-sectional view showing a camera module in which a filler material is not disposed according to an embodiment taken along line V-V′ of FIG. 3. FIG. 6 is a cross-sectional view showing a portion of a camera module according to an embodiment taken along line V-V′ of FIG. 3.

The sub-housing 600 may have a rectangular planar shape. The sub-housing 600 may have an opening 603 at a central portion, and the image sensor 500 may be positioned within the opening 603 of the sub-housing 600. The opening 603 of the sub-housing 600 may also have a rectangular planar shape.

The sub-housing 600 may have a step difference along the optical axis direction, and may include a frame portion 601 and a seating portion 602 that are sequentially connected.

The seating portion 602 may be disposed to surround the opening 603 overlapping the image sensor 500 at least partially. The seating portion 602 may be positioned between the opening 603 and the frame portion 601. The infrared filter 700 may be accommodated and mounted on the seating portion 602. Along the optical axis direction, the height of the seating portion 602 may be lower than the height of the frame portion 601. The seating portion 602 may have a rectangular planar shape but is not limited thereto.

The frame portion 601 may be supported by the substrate 400. The frame portion 601 may space the seating portion 602 to be apart from the substrate 400. The frame portion 601 may be positioned in an outer portion of the sub-housing 600 so as to surround the opening 603. The frame portion 601 may be disposed to surround the seating portion 602.

The frame portion 601 may include a connecting portion 6012 configured to space the seating portion 602 to be apart from the substrate 400 and extend from the seating portion 602, and a support portion 6011 positioned between the connecting portion 6012 and the substrate 400 and supported by the substrate 400. The connecting portion 6012 may be in a shape extending from the seating portion 602 in the direction perpendicular to the optical axis direction. The support portion 6011 may extend from one region of the connecting portion 6012 in the optical axis direction. In addition, the frame portion 601 may include a guide portion 6013 surrounding the seating portion 602 and protruding in the optical axis direction. The guide portion 6013 may guide a position on which the infrared filter 700 is seated.

Due to the opening 603 of the sub-housing 600, a space portion may be formed on an inner side of the sub-housing 600. The infrared filter 700 may be disposed above the space portion, and the image sensor 500 may be positioned below the space portion. The sub-housing 600 may have a gas discharge portion 800 penetrating the sub-housing 600. Accordingly, gas generated at the time of bonding the infrared filter 700 and the sub-housing 600 may be discharged from the interior space of the sub-housing 600 to an exterior of the sub-housing 600.

The sub-housing 600 may have an inner surface facing the image sensor 500 and an outer surface facing an exterior. Specifically, the inner surface of the sub-housing 600 may define an inner side space portion accommodating the image sensor 500, and the outer surface may mean a surface facing the exterior of the sub-housing 600, excluding the inner surface.

The gas discharge portion 800 may be positioned below the seating portion 602. The frame portion 601 may have the gas discharge portion 800. The gas discharge portion 800 may include a first channel 801 penetrating the sub-housing 600 from its inner surface to its outer surface, and a second channel 802 extending from the first channel 801 to an outer surface of the sub-housing 600 along the optical axis direction.

The first channel 801 may extend from an inner surface of the frame portion 601 to an outer side of the sub-housing 600. The first channel 801 may extend in the direction perpendicular to the optical axis direction. The first channel 801 may extend in a straight line. The first channel 801 may have a rectangular cross-sectional shape but is not limited thereto, and may have any shape that allows the gas to pass through the first channel 801. Referring to FIG. 5, the first channel 801 may penetrate the connecting portion 6012 from its inner surface to its outer surface.

The second channel 802 may extend from one region of the first channel 801 in the optical axis direction. The second channel 802 may extend in a straight line. The second channel 802 may have a rectangular cross-sectional shape, but is not limited thereto, and may have any shape that allows the gas to pass through the second channel 802.

The sub-housing 600 may have a first opening 604 penetrated by the first channel 801 and positioned on the inner surface and a second opening 605 penetrated by the first channel 801 and positioned on the outer surface. In other words, the first opening 604 and the second opening 605 may be positioned at both ends of the first channel 801, respectively. The first channel 801 may communicate with the interior space of the sub-housing 600 through the first opening 604, and may communicate with the exterior of the sub-housing 600 through the second opening 605. When the first channel 801 extends in a straight line in the direction perpendicular to the optical axis direction, the central axes of the second opening 605 and the first opening 604 may have the same height.

The sub-housing 600 may have a third opening 606 penetrated by the second channel 802 from the first channel 801 in the optical axis direction and positioned on the outer surface. A first end of the second channel 802 may communicate with the exterior of the sub-housing 600 through the third opening 606, and the second end may be connected to the first channel 801. When the first channel 801 extends in a straight line in the direction perpendicular to the optical axis direction, the third opening 606 and the second opening 605 may be aligned along the direction perpendicular to the optical axis direction.

Referring to FIG. 6, a filler material 900 may be disposed to fill at least a portion of the second channel 802. The filler material 900 may be disposed to fill a region where the first channel 801 and the second channel 802 overlap each other along the optical axis direction. The filler material 900 may include an adhesive material. The filler material 900 may include an epoxy resin. The filler material 900 may be disposed to fill at least a portion of the second channel 802 and a portion of the first channel 801 after the gas due to curing of an adhesive material is sufficiently discharged to the outside. As described above, by using the filler material 900 to seal a portion through which the gas discharge portion 800 communicates with the outside, the process defect due to entering flowable foreign substances of the outside through a part open for gas discharge may be prevented.

Since the gas discharge portion 800 is positioned below the seating portion 602, the seating portion 602 may not be provided with a separate structure for discharging gas. An adhesive may be disposed between the seating portion 602 and the infrared filter 700, and the adhesive may be disposed to cover a region where the seating portion 602 and the infrared filter 700 overlap each other. As described above, since the adhesive is applied to an entire region of an upper surface of the seating portion 602 overlapping the infrared filter 700, the flare phenomenon may be prevented compared to the case where a groove for gas discharge is positioned on the upper surface of the seating portion 602 such that a region that is not applied with exists.

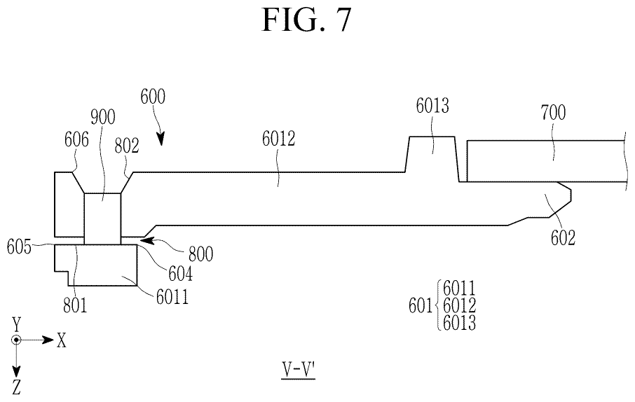

Hereinafter, referring to FIG. 7, the sub-housing 600 of a camera module according to a modified embodiment 10 will be described. FIG. 7 is a cross-sectional view showing a portion of a camera module according to a modified embodiment taken along line V-V′ of FIG. 3.

Unlike the above-described camera module according to an embodiment, in a camera module according to this modified embodiment, the gas discharge portion 800 may be positioned in a lower portion of the sub-housing 600 along the optical axis direction. In other words, the first channel 801 may penetrate the support portion 6011 from its inner surface to its outer surface.

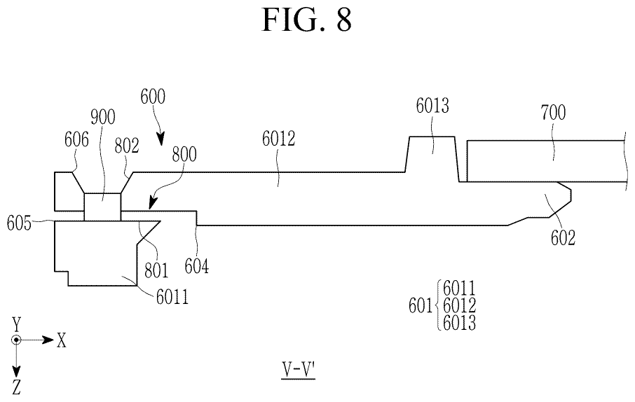

Hereinafter, referring to FIG. 8, the sub-housing 600 of a camera module according to another modified embodiment 10 will be described. FIG. 8 is a cross-sectional view showing a portion of a camera module according to another modified embodiment taken along line V-V′ of FIG. 3.

Unlike the above-described camera module according to an embodiment, in a camera module according to this modified embodiment, the first opening 604 may be positioned on a lower surface along the optical axis direction of the sub-housing 600.

In other words, referring to FIG. 7 and FIG. 8 together, a position of the first channel 801 may be configured in any other scheme, provided that the gas discharge portion 800 may connect an inner side space portion of the sub-housing 600 to the outside by penetrating the sub-housing 600 from the inner surface to the outer surface.

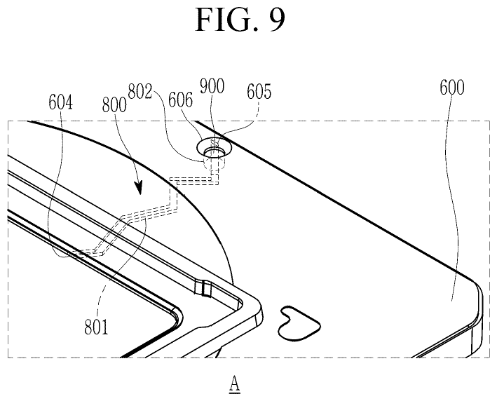

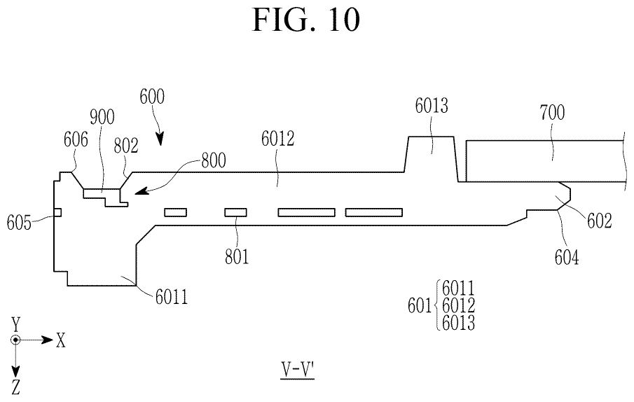

Hereinafter, referring to FIG. 9 and FIG. 10, the sub-housing 600 of a camera module, according to another embodiment 10, will be described in further detail. FIG. 9 is an enlarged perspective view of a portion A of a camera module according to another embodiment. FIG. 10 is a cross-sectional view showing a portion of a camera module according to another embodiment taken along line V-V′ of FIG. 3.

Referring to FIG. 9 and FIG. 10, a camera module, according to the present embodiment, is similar to a camera module, according to an embodiment described in reference to FIG. 1 to FIG. 6. Detailed descriptions of the same components are omitted.

Unlike the above-described camera module according to an embodiment, in a camera module according to this modified embodiment, the first channel 801 may have a plurality of bent portions. The first channel 801 may penetrate the connecting portion 6012 from its inner surface to its outer surface. The first channel 801 may have a rectangular cross-sectional shape, but is not limited thereto, and may have any shape that allows the gas to pass through the first channel 801.

In addition, when the first channel 801 extends in the direction perpendicular to the optical axis direction to have the plurality of bent portions, the third opening 606 and the second opening 605 may be disposed offset with respect to the direction perpendicular to the optical axis direction. As described above, by forming the gas discharge portion 800 in a curved shape rather than a straight line, the entrance of foreign substances from the outside may be effectively blocked while easily discharging gas due to the curing of an adhesive material to the outside.

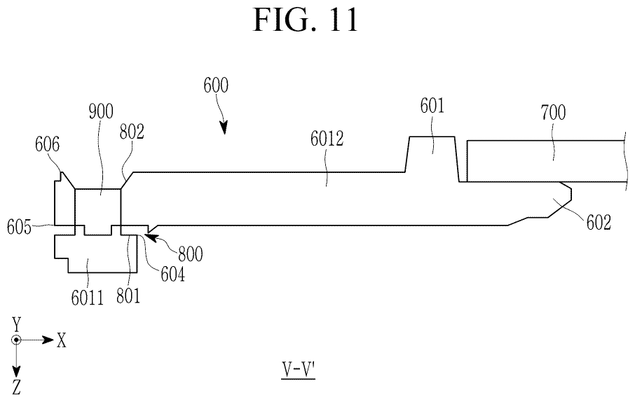

Hereinafter, referring to FIG. 11, a variation of a camera module according to another embodiment will be described. FIG. 11 is a cross-sectional view showing a portion of a camera module according to a modified embodiment of another embodiment taken along line V-V′ of FIG. 3.

Unlike the above-described camera module according to another embodiment, in a camera module according to this modified embodiment, the gas discharge portion 800 may be positioned in the lower portion of the sub-housing 600 along the optical axis direction. In other words, the first channel 801 may penetrate the support portion 6011 from its inner surface to its outer surface.

Referring to FIG. 10 and FIG. 11 together, the position of the first channel 801 may be configured in any other scheme, provided that the gas discharge portion 800 may connect the inner side space of the sub-housing 600 to the outside by penetrating the sub-housing 600 from the inner surface to the outer surface.

At least one of the embodiments attempts to provide a camera module capable of easily discharging gas due to curing an adhesive material to the outside and effectively blocking the entrance of foreign substances from the outside.

According to embodiments, the process defect due to the entering of flowable foreign substances of the outside through a part open for gas discharge may be prevented, the flare phenomenon may be prevented, and a camera module capable of easily discharging gas due to curing of an adhesive material to the outside and effectively blocking entrance of foreign substances from the outside may be provided.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens barrel;
an image sensor, mounted on a substrate, disposed below the lens barrel along an optical axis direction of the lens barrel; and
a sub-housing, disposed between the lens barrel and the substrate, comprising a seating portion on which an infrared filter is accommodated, and a frame portion supported by the substrate,
wherein the sub-housing is configured to space apart the seating portion from the substrate,
wherein the sub-housing comprises an inner surface facing the image sensor and an outer surface facing away from the inner surface, and
wherein the frame portion comprises a gas discharge portion comprising a first channel communicating the inner surface with the outer surface in a first direction and a second channel extending from the first channel to the outer surface along the optical axis direction in a second direction different from the first direction.

2. The camera module of claim 1, wherein the frame portion further comprises
a connecting portion configured to space apart the seating portion from the substrate and extend from the seating portion, and
a support portion disposed between the connecting portion and the substrate and supported by the substrate.

3. The camera module of claim 2, wherein the first channel penetrates the connecting portion to communicate inner and outer surfaces of the connecting portion.

4. The camera module of claim 2, wherein the first channel penetrates the support portion to communicate inner and outer surfaces of the support portion.

5. The camera module of claim 1, further comprising a filler material disposed to fill at least a portion of the second channel.

6. The camera module of claim 5, wherein the filler material is disposed to fill a region where the first channel and the second channel overlap each other along the optical axis direction.

7. The camera module of claim 5, wherein the filler material includes an epoxy resin.

8. The camera module of claim 1, wherein an adhesive is disposed between the seating portion and the infrared filter.

9. The camera module of claim 8, wherein the adhesive is disposed to cover a region where the seating portion and the infrared filter overlap.

10. The camera module of claim 1, wherein the sub-housing comprises
a first opening penetrated by the first channel and positioned on the inner surface, and
a second opening penetrated by the first channel and positioned on the outer surface.

11. The camera module of claim 10, wherein the sub-housing comprises a third opening penetrated by the second channel from the first channel in the optical axis direction and positioned on the outer surface.

12. The camera module of claim 11, wherein the third opening and the second opening are aligned along a direction perpendicular to the optical axis direction.

13. The camera module of claim 11, wherein the third opening and the second opening are disposed offset from a direction perpendicular to the optical axis direction.

14. The camera module of claim 10, wherein the first opening is positioned lower than the second opening in an optical axis direction of the sub-housing.

15. The camera module of claim 1, wherein the first channel extends in a direction perpendicular to the optical axis direction.

16. The camera module of claim 1, wherein the first channel extends in a straight line.

17. The camera module of claim 1, wherein the first channel has a plurality of bent portions.

18. The camera module of claim 1, wherein the second channel extends in a straight line.
